(19) United States
(12) Patent Application Publication
(10) Pub. No.: US 2017/0307024 A1
(43) Pub. Date: Oct. 26, 2017

(54) ENCODER FASTENING FOR FASTENING AN ENCODER SHAFT TO A DRIVE SHAFT, AND CORRESPONDING METHOD

(71) Applicant: SIEMENS AKTIENGESELLSCHAFT, München (DE)

(72) Inventor: AXEL KNAUFF, Münnerstadt (DE)

(73) Assignee: SIEMENS AKTIENGESELLSCHAFT, München (DE)

(21) Appl. No.: 15/528,680

(22) PCT Filed: Aug. 17, 2016
(86) PCT No.: PCT/EP2016/069469

§ 371 Date: May 22, 2017

(30) Foreign Application Priority Data
Sep. 29, 2015 (EP) 15187245.4

(51) Int. Cl. F16D 1/104; F16B 21/20; F16D 1/112; F16B 21/18; G01D 5/244

(52) U.S. Cl. CPC F16D 1/104; F16D 1/112; F16B 21/18; F16B 21/20; G01D 5/24423

(57) ABSTRACT

An encoder fastening for fastening an encoder shaft of an encoder system to a drive shaft includes a spring washer configured for placement in a slot of the drive shaft, and a radially elastic element which is arranged on the spring washer to maintain a connection between the drive shaft and the encoder shaft under radial tension, when the encoder shaft is inserted into the slot of the drive shaft.

The invention relates to an encoder fastening according to the preamble of claim 1. The invention further relates to a method according to the preamble of claim 17.

In electric motors, the encoder shaft is usually connected to the drive shaft in a fixed manner. The encoder shaft of rotary encoders for electric motors, in particular servomotors, is usually connected to the drive shafts using clamped joints or tapered seats. Screws are normally employed for this purpose.

The connection of the two axially aligned shafts is effected by means of an interference fit, this being produced by a cylindrical and hollow-cylindrical fit of both shafts and by a central fastening screw which connects both shafts together in an axial direction.

The securing of both shafts is achieved by tightening the fastening screw, whose shank passes through a central hole of the encoder shaft and whose screw thread is screwed into an internal thread of the drive shaft. The screw head in this case is situated at the end face of the encoder shaft or at the bottom of a hole in the end face of the encoder shaft. A thread of the fastening screw engages in an internal thread of a blind hole in the drive shaft, said blind hole being aligned with the central axial hole of the encoder shaft.

If a tapered seat is used, provision is made for e.g. a central screw. However, this is no longer possible if signal acquisition is required, because essential parts of the signal acquisition must be arranged centrally here.

Furthermore, the fastening by means of a screw also requires additional machining in the drive shaft, specifically the thread, and in the encoder shaft, specifically the drilled hole, and not least a screw.

The object of the present invention is therefore to specify an encoder fastening and a method for improved fastening of the drive shaft to the encoder shaft, thereby solving the problems cited above.

With regard to the encoder fastening, the object is achieved by the specification of an encoder fastening comprising a drive shaft and an encoder system having an encoder shaft, wherein for connection purposes the encoder shaft can be partially inserted into the drive shaft, into a slot provided therefor, wherein for fastening purposes a radially elastic element is arranged in the slot such that the connection is under radial tension, and the encoder fastening is embodied by the provision of a spring washer which is installed in the slot and on which the radially elastic element is arranged.

In this case, the radially elastic element takes the form of radially projecting leaf-like locking elements, wherein the spring washer has an inner circumferential side with an inner diameter and the encoder locking elements are arranged on the inner circumferential side, wherein the spring washer has an outer diameter on the outer circumferential side and the drive locking elements are arranged on the outer circumferential side, and wherein the encoder locking elements and the drive locking elements are so aligned as to oppose each other radially. The drive locking elements effectively point radially outwards in this case, while the encoder locking elements point radially inwards. The inner encoder locking elements serve to securely hold the encoder shaft, while the outer drive locking elements ensure the secure placement in the drive shaft.

With regard to the method, the object is achieved by the specification of a method for fastening an encoder, comprising a drive shaft and an encoder system having an encoder shaft, wherein for connection purposes the encoder shaft is partially inserted into the drive shaft, into a slot provided therefor, wherein the connection is under radial tension because a radially elastic element is arranged in the slot for fastening purposes, and the method is embodied by the installation of spring washer, on which the radially elastic element is arranged, in the slot.

The radially elastic element serves both to securely hold the encoder shaft and to ensure the secure placement in the drive shaft. By virtue of the elasticity, it is ensured that the connection is under radial tension in each case and therefore continues to function correctly.

By virtue of the invention, space is now provided for central positioning of the signal acquisition.

The method can be performed on the encoder fastening according to the invention.

Further advantageous measures are specified in the subclaims, and can be combined as desired in order to achieve further advantages.

The radially elastic element preferably takes the form of radially projecting leaf-like locking elements. In particular, the locking elements are bent and spaced from each other, effectively having a saw-tooth arrangement.

In a preferred embodiment, the locking elements take the form of encoder locking elements and drive locking elements. In this case, the encoder locking elements and the drive locking elements are so aligned as to oppose each other radially. In other words, the encoder locking elements and the drive locking elements point in respectively opposite directions.

The encoder locking elements are preferably bent in an axially opposite direction to the drive locking elements. This bent arrangement ensures ease of assembly while locking in an opposite direction. By virtue of this sprung characteristic, the shaft-hub connection that is formed by the drive shaft and the encoder shaft is under radial tension and therefore continues to function correctly in each case. This gives greater reliability in operation.

In an exemplary embodiment, at least the encoder shaft has an encoder circumferential outer side. The drive locking elements are arranged on this encoder circumferential outer side, pointing radially outwards, in order to securely hold the encoder shaft in the drive shaft. In this case, a plurality of rings of drive locking elements may be attached to the encoder circumferential outer side, providing greater reliability in operation. Furthermore, the drive shaft can have a drive circumferential inner side. The encoder locking elements in this type of configuration are so arranged on said drive circumferential inner side as to point radially outwards.

The drive locking elements can be connected to the drive shaft and the encoder locking elements to the encoder shaft in a detachable or non-detachable manner in this case.

Provision is preferably made for at least one of the drive locking elements to be connected to the corresponding encoder locking element by a bridge. This allows ease of fastening to the spring washer.

In a preferred embodiment, the drive locking elements are bent in an axially opposite direction to the encoder locking elements. This bent arrangement ensures ease of assembly while locking in an opposite direction.

The drive locking elements can be connected to the encoder shaft and the encoder locking elements to the drive shaft in a detachable or non-detachable manner in this case.

The radially elastic element preferably has a sprung characteristic. This sprung characteristic ensures that the shaft-hub connection is under radial tension in each case and therefore continues to function correctly in each case.

Further features, properties and advantages of the present invention are provided in the following description with reference to the appended schematic figures, in which:

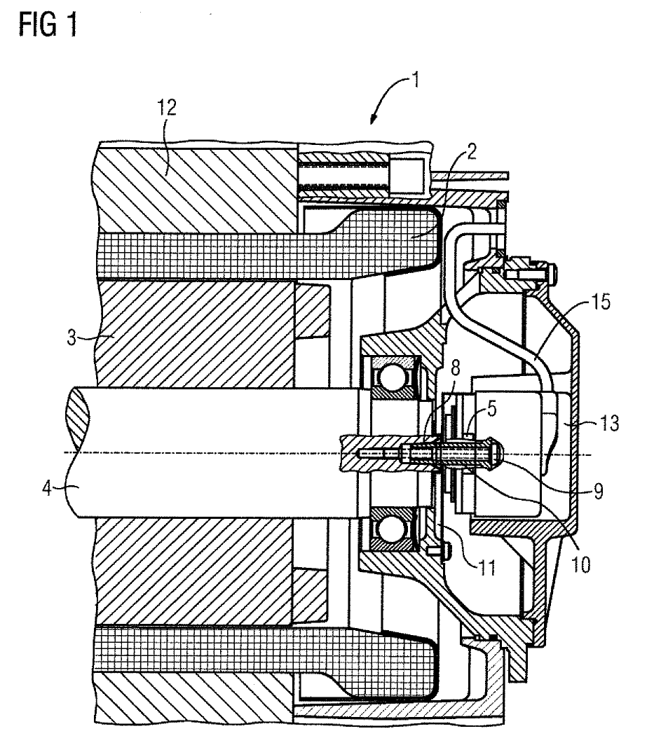

FIG. 1 shows a partial longitudinal section of an electrical machine in the region of the encoder system as per the prior art,

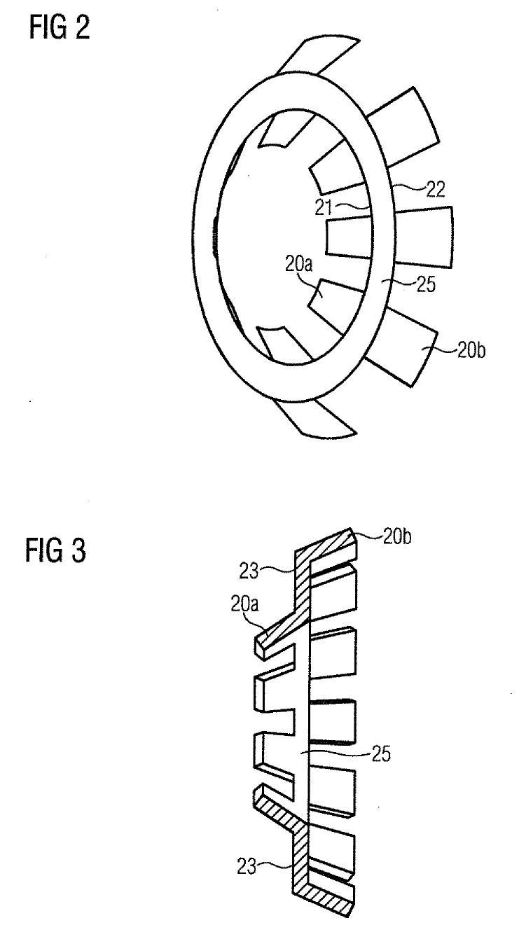

FIG. 2 shows a front view of a first example of a first encoder fastening,

FIG. 3 shows a side view of the first encoder fastening,

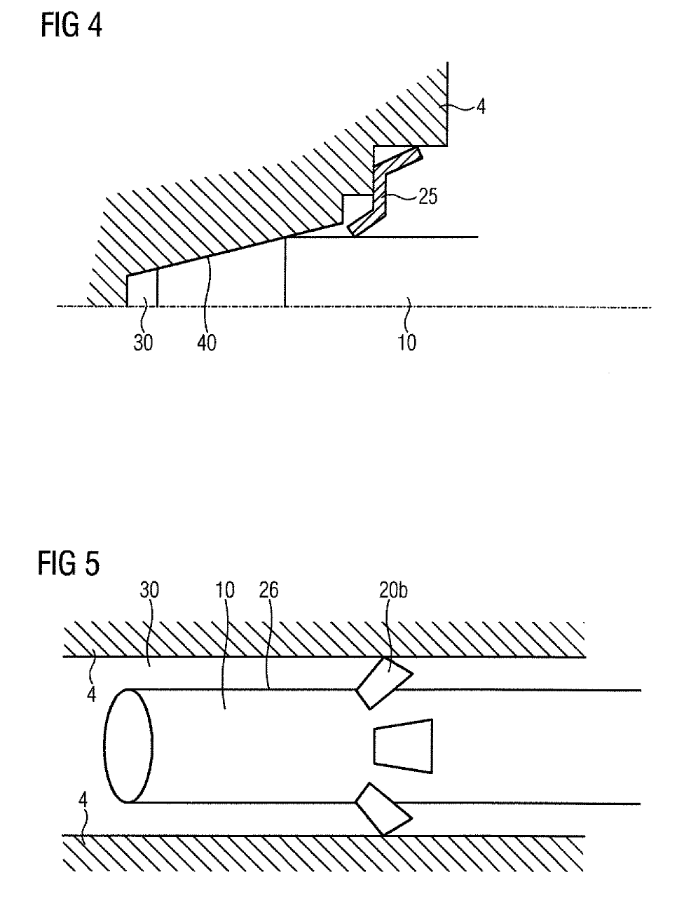

FIG. 4 shows the first encoder fastening in the integrated state,

FIG. 5 shows a side view of a second example of a second encoder fastening.

Although the invention is illustrated and described in detail with reference to the preferred exemplary embodiment, the invention is not restricted by the examples disclosed herein. Variations can be derived by a person skilled in the art without thereby departing from the scope of patent as defined in the following claims.

FIG. 1 shows a partial longitudinal section of an electric machine 1 comprising an encoder system 13 which is attached at the end face and has an encoder lead 15. in this case, the electric machine 1 can represent one of the known machine types such as asynchronous machines or synchronous machines, or another type in which encoders are used. The stator 12 with its winding 2 and the rotor 3 with its drive shaft 4 essentially form the electric machine 1. The encoder system 13 including torque bracket 11 and bearing 5 is situated at the end face of the rotor 3. In this case, the encoder system 13 comprises an encoder shaft 10, which is connected to the drive shaft 4 by means of a fastening screw 9. The drive shaft 4 has a socket 8 for this purpose.

Since essential parts of the signal acquisition must be arranged centrally, a structure featuring a fastening screw 9 is however not suitable for signal acquisition. Furthermore, the fastening by means of a fastening screw 9 requires additional machining in the drive shaft 4 (thread.) and in the encoder shaft 10 (drilled hole), and not least a screw 9. The object of the invention is to be able to dispense with all these things, thereby making space available for central positioning of the signal acquisition.

According to the invention, the encoder fastening is now effected using a radially elastic element. In this case, the radially elastic element can have encoder locking elements 20a and drive locking elements 20b (FIG. 2).

In this case, the encoder fastening can be embodied as a spring washer 25 as shown in a first example (FIG. 2). The spring washer 25 has an inner circumferential side 21 with an inner diameter, the encoder locking elements 20a being arranged on said inner circumferential side 21. The spring washer 25 also has an outer circumferential side 22 with an outer diameter, the drive locking elements 20b being arranged on said outer circumferential side 22. In this case, the encoder locking elements 20a and the drive locking elements 20b are so arranged as to point in radially opposite directions.

In this case, the drive locking elements 20b and the encoder locking elements 20a are bent in axially opposite directions. The inner encoder locking elements 20a serve to securely hold the encoder shaft 10, while the outer drive locking elements 20b ensure the secure placement in the drive shaft 4. The bent arrangement of the drive locking elements 20b/encoder locking elements 20a ensures ease of assembly while locking in an opposite direction. The sprung characteristic ensures that the shaft-hub connection, formed by the drive shaft 4 and the inserted encoder shaft 10, is under radial tension in each case and therefore continues to function correctly.

FIG. 3 shows a side view of a spring washer 25 having drive locking elements 20b and encoder locking elements 20a. In this case, the drive locking elements 20b and encoder locking elements 20a can be connected together by a bridge 23. The drive locking elements 20b and encoder locking elements 20a can be offset relative to each other and arranged in a saw-tooth manner around the outer circumferential side 22 and inner circumferential side 21 respectively. In this case, the drive locking elements 20b and encoder locking elements 20a can be connected to both the drive shaft 4 and the encoder shaft 10 in a detachable or non-detachable manner. Likewise, the drive locking elements 20b and encoder locking elements 20a can be connected to the spring washer 25 in a detachable or non-detachable manner. In this case, the encoder locking elements 20a are bent in the direction of insertion of the encoder shaft 10 into a slot 30 of the drive shaft 4. The drive locking elements 20b are bent in the opposite direction to the direction of insertion of the encoder shaft 10.

FIG. 4 shows the spring washer 25 with drive locking elements 20b (FIG. 2) and encoder locking elements 20a (FIG. 2) in the integrated state. The spring washer 25 is installed in the slot 30 in this case. A tapered seat designated by the reference numeral 40 allows better centering of the encoder shaft 10 in this case.

FIG. 5 shows a further exemplary embodiment of the invention. The encoder shaft 10 here has an encoder circumferential outer side 26 with drive locking elements 20b, said drive locking elements 20b being arranged on the encoder circumferential outer side 26 and pointing radially outwards. In this case, the drive locking elements 20b here are bent against the direction of insertion of the encoder shaft 10 in the slot 30 of the drive shaft 4. This means that the drive locking elements 20b ensure the secure placement in the drive shaft 4. In this case, provision can also be made for attaching a plurality of such rings of drive locking elements 20b to the encoder circumferential outer side 26. A further exemplary embodiment consists in first introducing the encoder shaft 10 into a type of expanding anchor, wherein at least the expanding anchor is equipped with such drive locking elements 20b and is designed to be inserted with the encoder shaft 10 in the slot 30.

Provision can obviously also be made for encoder locking elements 20a which are arranged directly on the drive shaft 4 or on the drive circumferential inner side of the drive shaft 4 and which point radially outwards (not shown).

1.-17. (canceled)

18. An encoder fastening for fastening an encoder shaft of an encoder system to a drive shaft, said encoder fastening comprising:
a spring washer configured for placement in a slot of the drive shaft; and
a radially elastic element arranged on the spring washer to maintain a connection between the drive shaft and the encoder shaft under radial tension, when the encoder shaft is inserted into the slot of the drive shaft.

19. The encoder fastening of claim 18, wherein the radially elastic element is configured as leaf-like locking elements radially projecting from the spring washer.

20. The encoder fastening of claim 19, wherein the locking elements are bent.

21. The encoder fastening of claim 19, wherein the locking elements are spaced from each other.

22. The encoder fastening of claim 19, wherein the locking elements are configured as encoder locking elements and drive locking elements, said encoder locking elements and drive locking elements being aligned such as to oppose each other radially.

23. The encoder fastening of claim 22, wherein the encoder locking elements are bent in an axially opposite direction relative to the drive locking elements.

24. The encoder fastening of claim 22, wherein the drive locking elements are arranged on an encoder circumferential outer side of the encoder shaft such as to point radially outwards.

25. The encoder fastening of claim 22, wherein the encoder locking elements are arranged on a drive circumferential inner side of the drive shaft such as to point radially outwards.

26. The encoder fastening of claim 24, wherein the drive locking elements are connected to the drive shaft in a detachable or non-detachable manner.

27. The encoder fastening of claim 25, wherein the encoder locking elements are connected to the encoder shaft in a detachable or non-detachable manner.

28. The encoder fastening of claim 18, wherein the spring washer has an inner circumferential side defined by an inner diameter and an outer circumferential side defined by an outer diameter, said radially elastic element being configured as leaf-like locking elements which radially project from the spring washer and are configured as encoder locking elements arranged on the inner circumferential side and drive locking elements arranged on the outer circumferential side, said encoder locking elements and drive locking elements being aligned such as to oppose each other radially.

29. The encoder fastening of claim 28, further comprising a bridge connecting at least one of the drive locking elements to a corresponding one of the encoder locking elements.

30. The encoder fastening of claim 28, wherein the drive locking elements are bent in an axially opposite direction relative to the encoder locking elements.

31. The encoder fastening of claim 28, wherein the drive locking elements are connected to the encoder shaft in a detachable or non-detachable manner,

32. The encoder fastening of claim 28, wherein the encoder locking elements are connected to the drive shaft in a detachable or non-detachable manner.

33. The encoder fastening of claim 18, wherein the radially elastic element has a sprung characteristic.

34. A method for fastening an encoder shaft of an encoder system to a drive shaft, said method comprising:
arranging a radially elastic element on a spring washer;
placing the spring washer with the radially elastic element in a slot of the drive shaft; and
partially inserting an encoder shaft into the slot of the drive shaft such that a connection between the drive shaft and the encoder shaft is maintained under radial tension.
